(19) United States
(12) Patent Application Publication
(10) Pub. No.: US 2005/0039184 A1
(43) Pub. Date: Feb. 17, 2005

(54) Assigning a process to a processor for execution

(75) Inventors: Aaron R. Kunze, Portland, OR (US); Jayaram Mudigonda, Austin, TX (US); Harrick M. Vin, Austin, TX (US); Arun Raghunath, Beaverton, OR (US)

Correspondence Address: FISH & RICHARDSON, PC, 12390 EL CAMINO REAL, SAN DIEGO, CA, 92130-2081, US

(73) Assignee: Intel Corporation

(21) Appl. No.: 10/640,879

(22) Filed: Aug. 13, 2003

(51) Int. Cl. G06F 9/46

(52) U.S. Cl. 718/103

(57) ABSTRACT

A method for assigning a process to a processor for execution includes determining a value that represents a degree of information sharing between one process and another process, grouping the processes into a process group based on the value, determining if the process group is executable in a memory associated with a processor, and associating the process group, if determined executable, with the memory associated with the processor.

### BACKGROUND

This application relates to a method for assigning a process to a processor for execution.

Processors such as microprocessors, central processing units (CPU's), and the like include logic circuitry that responds to a process residing in an execution space in a memory associated with the processor. Due to particular attributes of the processors, such a processing speed, memory space associated with the processor, and so forth, particular processes are more suitable for executing on one processor and not by another. Some processors such as network processors are designed to process streams of data packets received over a network such as a wide area network (WAN) and transmit the data packets to appropriate local destinations.

### DESCRIPTION OF DRAWINGS

FIG. 1 is a block diagram depicting a system for processing data packets.

FIG. 2 is a block diagram depicting an array of microengines.

FIGS. 3A-3F are a series of diagrams pictorially depicting process components being grouped and assigned for execution.

FIG. 4 is a flow chart of a process assignor.

### DESCRIPTION

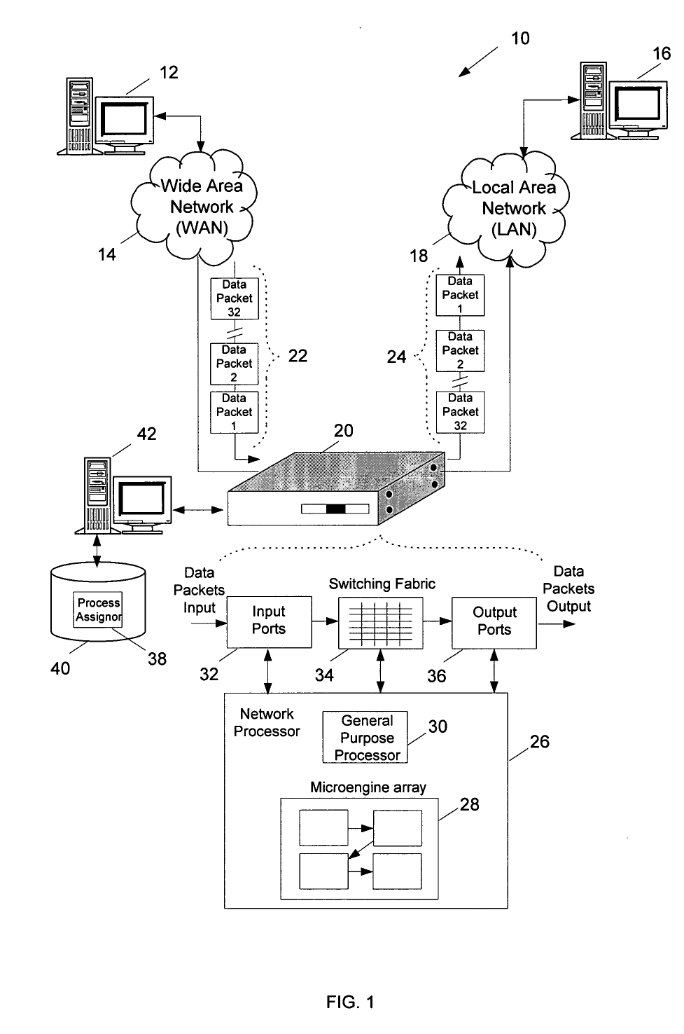

Referring to FIG. 1, a system 10 for transmitting data packets from a computer system 12 through a wide area network (WAN) 14 to another computer system 16 through a local area network (LAN) 18 includes a router 20 that collects a stream of data packets 22 and processes the data packets prior to transmitting an output stream of data packets 24 to the LAN 18 for delivery to the computer system 16. To produce the data packet stream 24 the router 20 includes a network processor 26 that processes the data packet stream 22 with an array of, e.g., four programmable multithreaded microengines 28. Each microengine executes instructions that are associated with an instruction set (e.g., a reduced instruction set computer (RISC) architecture) used by the array of microengines 28 included in the network processor 26. Since the instruction set is designed for specific use by the array of microengines 28, instructions are processed relatively quickly compared to the number clock cycles typically needed to execute instructions associated with a general-purpose processor. Each one of the microengines included in the array of microengines 28 has a relatively simple architecture and quickly executes relatively routine processes (e.g., data packet forwarding, data packet converting, etc.) while leaving more complicated processing (e.g., routing table maintenance) to other processing units such as a general-purpose processor 30 (e.g., a StrongArm processor of ARM Limited, United Kingdom) also included in the network processor 30.

Typically the data packets are received by the router 20 on one or more input ports 32 that provide a physical link to the WAN 18 and are in communication with the network processor 26 that controls the entering of the incoming data packets. The network processor 26 also communicates with a switching fabric 34 that interconnects the input ports 32 and output ports 36. The output ports 36, which are also in communication with the network processor 26, are used for scheduling transmission of the data packets to the LAN 18 for reception at the computer system 16. To schedule the transmission of the data packets, or other similar functions associated with the data packets, the network processor 26 executes one or more processes with the microengines in the array 28 by assigning portions of the one or more processes, referred to here as a process components, to individual microengines so that the processes are efficiently executed by the network processor. In some arrangements, a process is a complete sequence of instructions executed on data sent from and/or received by a device on the network. Additionally, in some arrangements a process component is a programmer-identified subset of consecutive instructions included in a process. Furthermore, in some arrangements, a process component is a thread (e.g., an autonomous piece of software that does not complete), a subroutine, a program, or other similar programming structures. Additionally, in some arrangements a process is a group of threads, subroutines, programs, or other similar programming structures. Typically passing data packets between process components on the same microengine is more efficient than passing data packets between process components on different microengines.

To assign each of the process components to an appropriate microengine in the array 28, a process assignor 38, which is stored in a storage device 40, is executed by a computer system 42 in communication with the router 20. In some arrangements the computer system 42 is in direct communication with the network processor 26 to assign the process components to the appropriate microengines. Also, in some arrangements the process assignor 38 is executed in the router 20 by the network process 26 or another processor, so that one or more of the process components is assignable and re-assignable to appropriate microengines in nearly real-time as the data packets are processed. By assigning the process components in nearly real-time, executing of the process components along with the overall process is continuously monitored for more efficient assignments of the process components. Furthermore, in addition to assigning process components to the microengines in the array 28, in some arrangements the process assignor 38 assigns one or more process components or processes to other processors included in the network processor such as the general-purpose processor 30. Also, in some arrangements the process assignor 38 is used to assign processes or process components to other processing devices (e.g., microprocessors) for efficient execution. Typically to assign a process component, the process assignor 38 determines assignments based on processing similarities (e.g., data packet sharing, etc.) among the process components along with the capabilities (e.g., processing speed) and attributes (e.g., associated memory space) of each microengine.

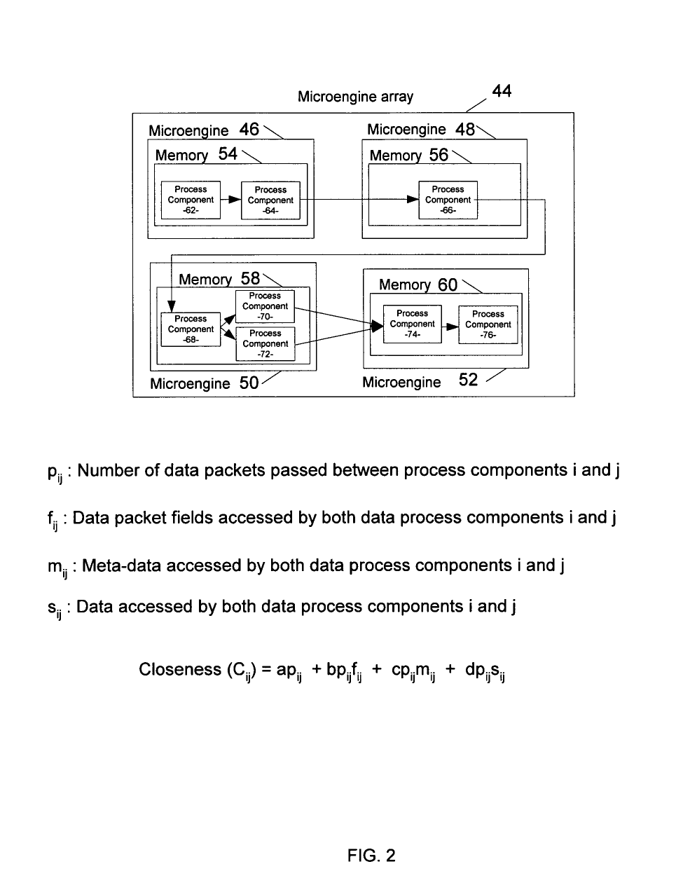

Referring to FIG. 2, a microengine array 44 is shown that includes four microengines 46-52 that respectively include associated memory 54-60 (e.g., RAM, ROM, etc.) used in conjunction with execution of process components assigned to the respective microengines. In some arrangements each memory space 54-60 is a control store that stores instructions to be executed by the respective microengine 46-52. Also, in some arrangements one or more of the memory spaces 54-60 is a portion of a larger memory that is partitioned into portions for use by the microengines. However, in this particular example each memory space 54-60 is included in one respective microengine 46-52 and assigned one or more process components of one or more processes (e.g., data packet forwarding, etc.) for execution. In this specific example, microengine 46 executes process component 62 and 64 in memory space 54, microengine 48 executes process component 66 in memory space 56, microengine 50 executes process components 68, 70, and 72 in memory space 58, and microengine 52 executes process components 74 and 76 in memory space 60. By respectively assigning each of the process components 62-76 to one of the four microengines 46-52 the process components execute efficiently (e.g., process data packets) to improve the performance of the network processor 26 and the router 20.

Typically to assign the process components, the process assignor 38 determines if particular process components function similarly. For example, if two or more process components both use similar data (e.g., process the same data packets) or similar information (e.g., identify a particular input port receiving data packets), the process assignor 38 attempts to assign these process components to the same microengine. By being assigned to the same microengine, the process components execute more efficiently since data and information is more efficiently shared. For example by executing two particular process components on the same microengine, data packets are transferred more efficiently between the process components since the components are sharing of the same attributes of the microengine (e.g., memory space, registers, etc.).

Alternatively, for example, to pass data packets between process components that are assigned to different microengines, one process component typically needs to write the data packets into memory space (e.g., a queue) that is accessible by the second microengine so that a second process component can read the data packets for processing on the second microengine. Passing data packets in this fashion is relatively slow and increases the number of clock cycles and processing time to process the data packets through each microengine. However, when data packets are passed between process components assigned to the same microengine, the data packet is relatively quickly accessible by both process components from the same memory space (e.g., register, etc.) associated with the microengine. So by assigning process components that share the same data packets to the same microengine, the assigned process components execute more efficiently. Also, if two or more process components access a particular data field of one or more data packets and are assigned to the same microengine, one of the process components can read the data field and place the data in a memory location (e.g., a register, cache, etc.) that is commonly accessible to each of the process components. By placing the data in the common memory location, the other process components are relieved from reading the data field and processing time is conserved.

To efficiently process the data packets the process assignor 38 attempts to assign each of the process components to an appropriate microengine. To determine which process component is assigned to a particular microengine, the process assignor 38 determines a numerical value that associates with each pair of process components. Each numerical value provides a measure of data and information that is shared between the process components. In this particular arrangement the numerical value is referred to as a “closeness factor”. By computing the closeness factor between a pair of process components, the process assignor 38 determines whether or not to group the pair of process components together and assign them to a particular microengine.

To determine a closeness factor between each pair of process components, the process assignor 38 typically determines a closeness factor for each pair of process components that communicate with one another by passing data packets (e.g., one-way data packet passing, two-way data packet passing, etc.). For example, process component 62 and 64 are in communication and the process assignor 38 determines a closeness factor to determine if the pair can be grouped and assigned to a microengine. Also, process components 64 and 66 are in communication and the process assignor 38 determines a closeness factor associated with that pair of process components. However, in this example process component 62 and 66 do not directly transfer data packets and typically the process assignor 38 does not compute a closeness factor associated with that particular pair of process components.

To calculate the closeness factor for each pair of communicating process components the process assignor 38, for example, determines and uses four factors. The first factor provides a measure of the number of data packets that pass between the two process components. In this arrangement the first factor is represented by the variable pᵢⱼ where “i” identifies the process component transferring the data packets and “j” identifies the process component the receiving the data packets.

The second component used in determining the closeness factor for each pair of communicating process components is a measure of data packet field portions accessed (e.g., read, written, etc.) by both process components. In this arrangement the second factor is represented by the variable fᵢⱼ where “i” identifies one process component and “j” identifies a second process component that communicates with the first. In some arrangements the second factor provides the number of data packet field bytes that both component “i” and component “j” access. For example, process component “i” accesses an Internet protocol (IP) source address field included in a data packet that is 4 bytes in length and an IP destination address field that is also 4 bytes in length. Process component “j” also accesses the 4 byte IP source address field along with an IP protocol field that is 2 bytes in length. Since the IP source address field is accessed by both process components, the second factor (i.e., fᵢⱼ) associated with process components “i” and “j” is equal to 4 bytes or another measuring unit (e.g., bits, Kbytes, Mbytes, etc.).

The third factor used in determining the closeness factor for each pair of communicating process components provides a measure of information accessed (e.g., read, written, etc.) by each process component included in the pair. Typically this information is associated with a data packet but is not stored within the data packet. For example, information such as meta-data that identifies, e.g., the particular input port of the router 20 that received the associated data packet. In this arrangement the third factor is represented by a variable mᵢⱼ where again “i” identifies one process component and “j” identifies a second process component that communicates with the first. In some arrangements the third factor measures information (e.g., meta-data) accessed by both component “i” and component “j” in bytes or another measuring unit (e.g., bits, Kbytes, Mbytes, etc.).

The fourth factor used in determining the closeness factor associated with each pair of communicating process components measures data accessed by both of the process components for processing (e.g., data packet processing). For example, both of the process components access a data structure (e.g., an array, a file, a record, a table, a tree, etc.) that organizes data and is stored in a particular memory location and uses data included in the structure to process data packets. More efficient processing is achievable by locally storing the accessed data in memory space that is relatively quickly accessible by both process components assigned to the microengine associated with the memory space. In this arrangement the fourth factor is represented by a variable sᵢⱼ where “i” identifies one process component and “j” identifies a second process component that communicates with the first. In some arrangements the fourth factor provides the data structure portions accessed by both process components “i” and “j” in bytes or another measuring unit (e.g., bits, Kbytes, Mbytes, etc.).

By determining each of the four factors for each pair of communicating process components, a closeness factor is calculated by the process assignor 38 to provide a measure of processing similarity and to be used in determining whether to group and assign the process components to the same microengine. In some arrangements the closeness factor is calculated as a function of all four factors. In this arrangement the closeness factor is represented by the variable Cᵢⱼ where “i” identifies one process component and “j” identifies a second process component that communicates with the first. One exemplary equation to calculate the closeness factor (i.e., Cᵢⱼ) for two process components is:
Cᵢⱼ=apᵢⱼ+bpᵢⱼfᵢⱼ+cpᵢⱼmᵢⱼ+dpᵢⱼsᵢⱼ (1)

Where “a”, “b”, “c”, and “d” are scaling factors that reflect the architecture of the microengines, the network processor 26, or other similar processor being assigned one or more processes or process components by the processor assignor 38. For example, if meta-data is stored in a memory space that is relatively quickly accessible, the scaling factor (i.e., c) associated with the third factor (i.e., mᵢⱼ) typically has a smaller value than if the meta-data is stored in memory space that is relatively slowly accessible. After the closeness factor has been determined for each pair of communicating process components, the process assignor 38 uses the calculated closeness factors to assign the process components to appropriate microengines.

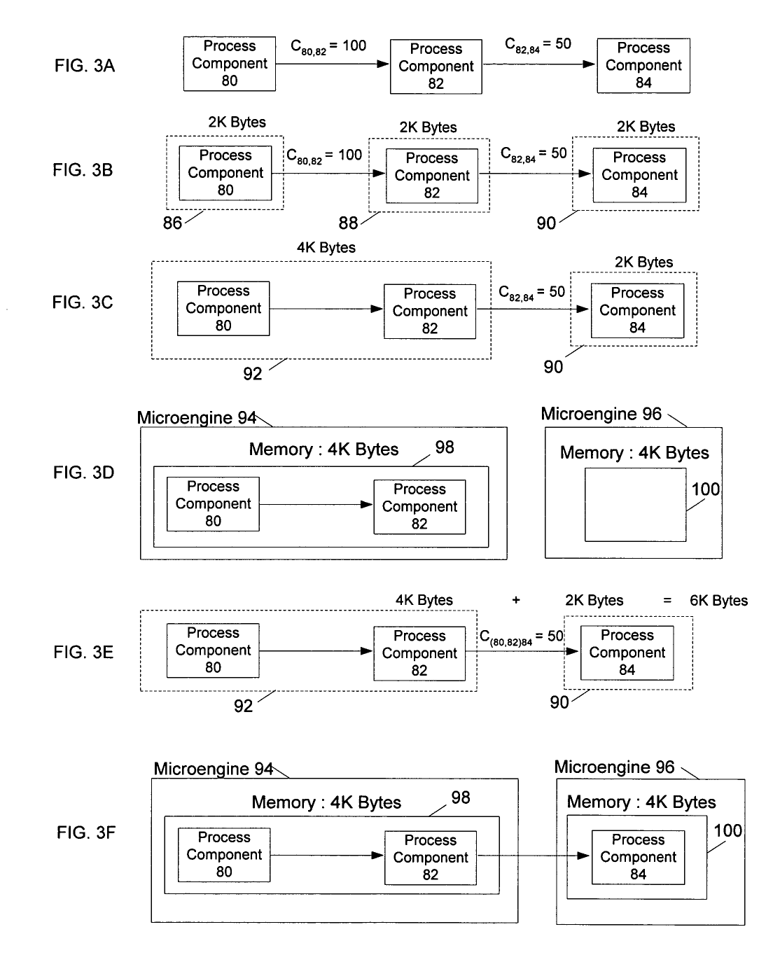

Referring to FIGS. 3A-3F, a series of diagrams depict three process components being assigned to two microengines for execution. In this particular example the process assignor 38 (shown in FIG. 1) determined the closeness factor for each unique pair of communicating process components.

Referring to FIG. 3A, component process 80 communicates with process component 82. The process assignor 38 determines the four factors associated with the pair and uses the four factors to determine a closeness factor (i.e., C_{80,82}). For demonstrative purposes, in this example, the closeness factor C_{80,82} has a value of 100. Additionally, the process component 82 is in communication with process component 84 and the process assignor 38 determines the four factors associated with this particular pair and calculates a closeness factor (i.e., C_{82,84}). In this particular example the closeness factor is calculated to equal 50 and is smaller than the calculated closeness factor of C_{80,82}.

Referring to FIG. 3B, each of the process components are assigned to a unique process component group as indicated by respective dashed-line boxes 86, 88, 90 by the process assignor 38. By assigning each process component to a respective process component group, the process assignor 38 determines if memory space associated with each of the microengines is capable of executing the process component included in a particular process component group. Additionally, the process assignor 38 attempts to combine two or more of the process component groups to form a larger process component group so that the process components included in the two or more process component groups are assigned to be executed on the same a microengine to improve processing efficiency. In this particular example, each of the process components 80, 82, 84 need 2 Kbytes of memory space for executing as indicated with each process component group 86, 88, 90.

Referring to FIG. 3C, since the closeness factor C_{80,82} is larger than C_{82,84} the process assignor 38 determines that process components 80 and 82 share more data and information than process components 82 and 84. Based on the larger closeness factor, the process assignor 38 attempts to group process components 80 and 82 on a single microengine ahead of attempting to group process components 82 and 84. In this arrangement to determine if process component 82 and 84 can be grouped, the process assignor 38 compares the memory space needed to execute the group of process components with the memory space available in each microengine. As indicated with the dashed-line box 92, by grouping the process components 80, 82 respectively included in the process component groups 86 and 88, the memory space needed to execute both process components is the aggregate of the memory space needed to execute each of the individual process components. In this example, the process component group 92 needs 4 Kbytes of memory space for executing both of the process components included in the process component groups 86 and 88.

Prior to assigning the group to a microengine, the process assignor 38 determines if one of the microengines has the appropriate amount of memory space available to execute the process component group 92.

Referring to FIG. 3D, in this particular example two microengines 94, 96 are capable of being assigned one or more process components for executing. Both microengines 94, 96 respectively include 4 Kbytes of memory space 98, 100 for executing process components or other processes. Since the process component group 92 needs 4 Kbytes of memory space, the process assignor 38 assigns the group to either microengine 94 or 96. In this example the process component group 92 is assigned to the memory space 98 associated with microengine 94.

Referring to FIG. 3E, after assigning the process component group 92, the process assignor 38 repeats by determining if another process component group can be produced from the current process component groups and assigned to a single microengine. In this example, process component group 92 and process group 90 are the current groups and the process assignor 38 calculates the closeness factor between these two process component groups. In some arrangements to calculate the closeness factor between the process component group 92 and process component group 90, the process assignor 38 sums the closeness factors associated with each unique combination of process component pairs associated with process component 92 and process component group 90. So for this example the closeness factor (i.e., C_{(80,82)84}) between process component group 92 and 90 is represented as:
C_{(80,82)84}=C_{80,84}+C_{82,84} (2)

In this particular example, process component 80 and process component 84 do not transfer data packets nor share any information or data. So for this example the closeness factor C_{80,84} is equal to zero and the closeness factor C_{(80,82)84} is equal to C_{82,84} that has a value of 50 as shown in FIG. 3(c). Alternatively, in other arrangements the process assignor 38 uses one or more other equations or mathematical relationships to calculate the closeness factor between process component groups 92 and 90. For example, the process assignor 38 may subtract, multiple, or perform one or more other similar mathematical operations to calculate the closeness factor. In some arrangements the closeness factor is recomputed, e.g., using equation (1) with “i” and “j” identifying process component groups rather than individual process components.

After the closeness factor C_{(80,82)84} is calculated, the process assignor 38 calculates the closeness factors associated with other process component group pair to determine which process component group pair is associated with the largest closeness factor. In this particular example since only two process component groups (i.e., process component group 92 and 90) are present, the closeness factor C_{(80,82)84} is the largest and the process assignor 38 determines if the process component groups 92 and 90 can be grouped together and assigned to a microengine. Similar to assigning process component group 92 to microengine 94, the process assignor 38 determines whether or not to group and assign process component groups 92 and 90 to a microengine based on the memory space available on the microengine. However, in some arrangements the process assignor 38 bases the determination on the processing speed of each microengine, storage space associated with the microengine, architecture of the microengine, or other individual or combination of microengine characteristics associated with the process component groups being executable in the memory of the microengine.

In this particular example the process assignor 38 determines that 6 Kbytes of memory space is needed for executing both for the process component group 92, which needs 4 Kbytes of memory space, and the process component group 90, which needs 2 Kbytes of memory space. However each of the microengines 94 and 96 are only capable of executing process components in the respective 4 Kbytes of memory spaces 98 and 100. So neither of the two microengines 94, 96 are capable of individually executing all three of the process components 80, 82, 84.

Referring to FIG. 3F, since the process assignor 38 determined that process component group 92 and process component 90 cannot be executed together on either of the microengines 94 and 96, the process assignor 38 assigns the process component group 90 to microengine 96 for execution. Additionally, since microengine 96 includes 4 Kbytes in memory space 100 and process component group 90 needs 2 Kbytes of memory space for executing, in some arrangements one or more additional process components (not shown) are assigned to execute in the remaining 2 Kbytes of the memory space 100. So, by assigning the process component 80 and process component 82 to microengine 94, the process assignor 38 assigned the two process components that share the larger amount of data, as shown by the closeness factor (i.e., C_{80,82}), to the same microengine to provide efficient data packet processing.

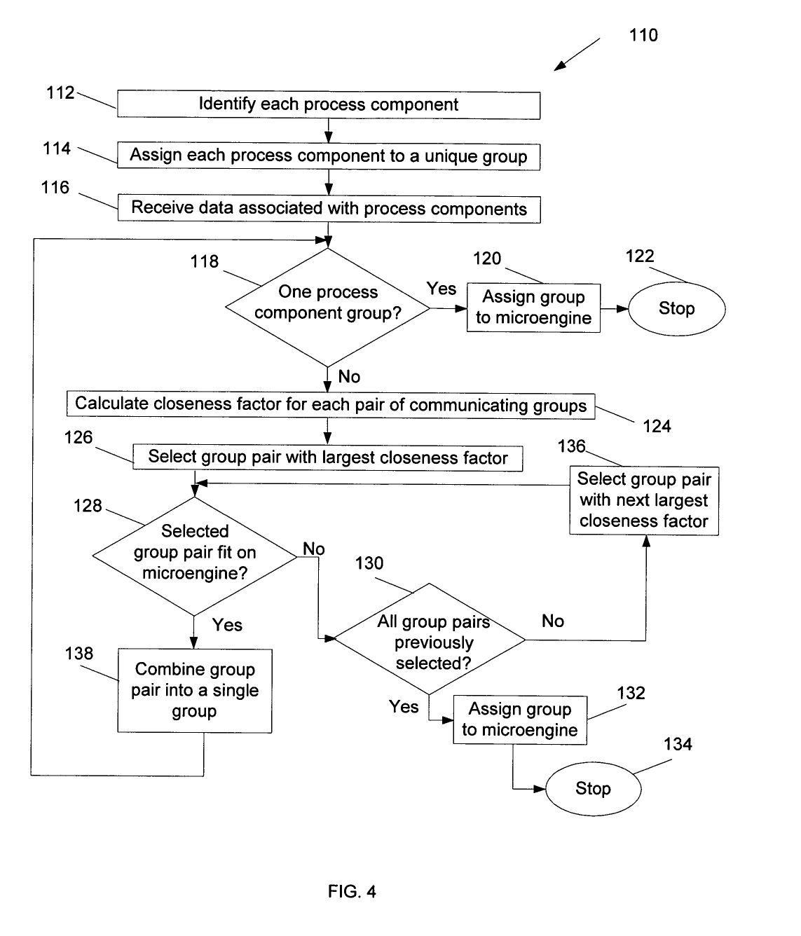

Referring to FIG. 4, a process assignor 110 includes identifying 112 each process component to be assigned by the process assignor to a microengine or other processor such as a microprocessor, etc. Also, in other arrangements besides assigning process components, the process assignor 110 assigns subroutines, software modules, or other processes to one or more microengines or other similar processing devices for execution. After identifying 112 the process components, the process assignor 110 assigns 114 each process component to a unique process component group.

By assigning each of the process components to process components groups, (as indicated with the dashed-line boxes 86, 88, 90, in FIG. 3B) the process assignor uses the groups to determine whether to combine the groups into larger groups and assign the larger groups to a single microengine for more efficient executing of the process components. After assigning 114 each process component to a unique process component group, the process assignor 110 receives 116 data associated with the process components. In some arrangements the data provides information for the process assignor 110 to determine each of the four factors (i.e., pᵢⱼ, fᵢⱼ, mᵢⱼ, and sᵢⱼ) used to calculate the closeness factor (i.e., Cᵢⱼ) between each pair of communicating process components. After receiving 116 the data, the process assignor 110 determines 118 if there is only one process component group. If determined that there is only one process component group the process assignor 110 assigns 120 the process component group to a microengine and stops 122 since two component process groups are needed for calculating a closeness factor. However, in some arrangements if determined that there is only one process component group the process assignor 110 stops 122 and the process component group is associated with a microengine by a process other than the process assignor 110. For example, after the process assignor 110 determines that all the process component groups have been combined into one process component group, a process other than the process assignor assigns the one process component group to a microengine. Furthermore, in some arrangements the one process component group, or multiple process component groups, is assigned to more than one microengine for providing redundancy by replicating the groups.

If determined that more than one process component group is present, the process assignor 110 calculates 124 the closeness factor for each pair of communicating (e.g., passing data packets) process components groups. Typically for calculating the closeness factors, the process assignor uses the four factors Pᵢⱼ, fᵢⱼ, mᵢⱼ, and sᵢⱼ and equation (1). However, in other arrangements the closeness factor is calculated from another mathematical relationship between one or more of the four factors.

After calculating 124 the closeness factor for each communicating pair, the process assignor 110 selects 126 the pair of process component groups associated with the largest closeness factor. After selecting 126 the pair with the largest closeness factor, the process assignor 110 determines 128 if the selected group pair appropriately fits on one of the microengines. Typically, to determine if the selected process component pair fits on the microengine, the process assignor 110 compares the amount of memory space needed by the process component pair to the amount of memory space available in the microengine. However, in some arrangements the determination if the selected process component group fits is based individually or in combination with one or more other attributes of the microengines such as processing speed, associated storage capabilities, etc.

If determined that the selected process component group does not fit on the microengine, the process assignor 110 determines 130 if each pair of process component groups has been selected. If each pair has not been selected, the process assignor 110 selects 136 the next pair of process component groups with the next largest calculated closeness factor and returns to determine 128 if that selected group pair fits on a microengine. If determined that each pair has been selected, the process assignor 110 assigns 132 the process component groups to one or more microengines and stops 134. However, in some arrangements, rather than assign the process component groups, if determined that each pair has been selected, the process assignor 110 stops 134 and the assignments are performed by a process other than the process assignor 110.

If determined that the selected pair of process component groups fit on a microengine, the process assignor 110 combines 138 the pair of process component groups into a single group and returns to determine 118 if there is now one process component group and the process assignor 110 repeats the operations. Additionally, in some arrangements, if the number of process component groups is less than that number of microengines, one or more of the process component groups are replicated and assigned to more than one microengine by the process assignor 110.

The process assignor 110 described herein can be implemented in digital electronic circuitry, or in computer hardware, firmware, software, or in combinations of them. The process assignor 110 described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Particular embodiments have been described, however other embodiments are within the scope of the following claims. For example, the operations of the process assignor 110 can be performed in a different order and still achieve desirable results.

1. A method for assigning a process to a processor for execution, the method comprising:
determining a value that represents a degree of information sharing between a first process and second process;
grouping the first and second process into a process group based on the value;
determining if the process group is executable in a memory associated with a processor; and
associating the process group, if determined executable, with the memory associated with the processor.

2. The method of claim 1, wherein determining the value includes determining an amount of data packets passed from the first process to the second process.

3. The method of claim 1, wherein determining the value includes determining a portion of a data packet accessed by the first process and the second process.

4. The method of claim 1, wherein determining the value includes determining an amount of data packet information accessed by the first process and the second process with the data packet information being stored separate from the data packet.

5. The method of claim 1, wherein determining the value includes determining an amount of data accessed by the first process and the second process with the data being used to process data packets with the data being different from data included in the data packets.

6. The method of claim 1, wherein grouping the first and second process is based on the value being larger than another value representing information sharing.

7. The method of claim 1, wherein determining if the process group is executable in the memory includes determining if the process group is storable in the memory.

8. The method of claim 1, wherein if the process group is determined unexecutable in the memory, associating the first process, if determined executable in the memory, with the processor for execution.

9. The method of claim 1, further comprising:
repeating determining the value, grouping, and determining if executable, with the process group and a third process.

10. A computer program product, tangibly embodied in an information carrier, for assigning a process to a processor for execution, the computer program product being operable to cause a machine to:
determine a value representing information sharing between a first process and second process;
group the first and second process into a process group based on the value;
determine if the process group is executable in a memory associated with a processor; and
associate the process group, if determined executable, with the memory associated with the processor.

11. The computer program product of claim 10, wherein determining the value includes determining an amount of data packets passed from the first process and to the second process.

12. The computer program product of claim 10, wherein determining the value includes determining a portion of a data packet accessed by the first process and the second process.

13. The computer program product of claim 10, wherein determining the value includes determining an amount of data packet information accessed by the first process and the second process with the data packet information being stored separate from the data packet.

14. The computer program product of claim 10, wherein determining the value includes determining an amount of data accessed by the first process and the second process with the data being used to process data packets with the data being different from data included in the data packets.

15. The computer program product of claim 10, wherein grouping the first and second process is based on the value being larger than another value representing information sharing.

16. The computer program product of claim 10, wherein determining if the process group is executable in the memory includes determining if the process group is storable in the memory.

17. The computer program product of claim 10, wherein if the process group is determined unexecutable in the memory, associating the first process, if determined executable in the memory, with the processor for execution.

18. The computer program product of claim 10 being further operable to cause a machine to:
repeat determining the value, grouping, and determining if executable, with the process group and a third process.

19. A process assignor comprises:
a process to determine a value that represents a degree of information sharing between a first process and second process;
a process to group the first and second process into a process group based on the value;
a process to assess if the process group is executable in a memory associated with a processor; and
a process to associate the process group, if determined executable, with the memory associated with the processor.

20. The process assignor of claim 19, wherein determining the value includes determining an amount of data packets passed from the first process to the second process.

21. The process assignor of claim 19, wherein determining the value includes determining a portion of a data packet accessed by the first process and the second process.

22. The process assignor of claim 19, wherein determining the value includes determining an amount of data packet information accessed by the first process and the second process with the data packet information being stored separate from the data packet.

23. The process assignor of claim 19, wherein determining the value includes determining an amount of data accessed by the first process and the second process with the data being used to process data packets with the data being different from data included in the data packets.

24. The process assignor of claim 19, wherein grouping the first and second process is based on the value being larger than another value representing information sharing.

25. The process assignor of claim 19, wherein assessing if the process group is executable in the memory includes determining if the process group is storable in the memory.

26. The process assignor of claim 19, wherein if the process group is determined unexecutable in the memory, associating the first process, if determined executable in the memory, with the processor for execution.

27. The process assignor of claim 19, wherein the process to determine a value, the process to group, and the process to assess repeat using the process group and a third process.

28. A system comprising a processor capable of:
determining a value representing information sharing between a first process and second process;
grouping the first and second process into a process group based on the value;
determining if the process group is storable in a memory associated with the processor; and
associating the process group, if determined storable, with the memory associated with the processor.

29. The system of claim 28, wherein determining the value includes determining an amount of data packets from the first process to the second process.

30. The system of claim 28, wherein determining the value includes determining a portion of a data packet accessed by the first process and the second process.

31. A system comprising:
a router including an input port for receiving data packets and a switch fabric for determining the destination of the data packets; and
a processor capable of,
determining a value representing information sharing between a first process and second process,
grouping the first and second process into a process group based on the value,
determining if the process group is storable in a memory associated with the processor, and
associating the process group, if determined storable, with the memory associated with the processor.

32. The system of claim 31, wherein determining the value includes determining an amount of data packets passed from the first process to the second process.

33. The system of claim 31, wherein determining the value includes determining a portion of a data packet accessed by the first process and the second process.

34. A method for assigning process components to an engine included in a network processor, the method comprising:
determining a metric that represents a degree of information sharing between a first process component and a second process component;
grouping the first and second process components into a process group based on the metric;
determining if the process group is executable in a memory associated with the engine included in the network processor; and
assigning the process group, if determined executable, with the memory associated with the engine included in the network processor.

35. The method of claim 34, wherein the network processor includes a second engine.

36. The method of claim 34, wherein the engine is multithreaded.
